(19) United States
(12) Patent Application Publication
(10) Pub. No.: US 2007/0033263 A1
(43) Pub. Date: Feb. 8, 2007

(54) Methods and apparatus for providing integrated bandwidth dedicated transport services

(76) Inventors: Scott Christopher Goering, Naperville, IL (US); Parley Carper Casto, Aurora, IL (US); Robin Marie Gustafson, Winfield, IL (US); Michael Edward Hillegonds, Crystal Lake, IL (US); Daniel Mark Lackhouse, Antioch, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/199,872

(22) Filed: Aug. 8, 2005

(51) Int. Cl. G06F 15/16

(52) U.S. Cl. 709/217

(57) ABSTRACT

Methods and apparatus for providing dedicated transport communication services are disclosed. A disclosed method provides a customer with first and second access ports to a circuit based communications network. Each access port has at least one associated bandwidth attribute. The method configures the communications network to route traffic between the first and second access ports in response to an operator of the communications network.

### FIELD OF THE DISCLOSURE

This disclosure relates generally to circuit based communication services and systems and, more particularly, to methods and apparatus for providing integrated bandwidth dedicated transport services.

### BACKGROUND

Currently, a dedicated transport customer purchases (i.e., leases) from a service provider a plurality of specific circuit based communication facilities (e.g., Digital Signal Level 1 (DS 1), Digital Signal Level 3 (DS3), Optical Carrier Level N (e.g., OC-3, 12, 48 and 192), multiplexers, etc.) that provide communicative coupling between a plurality of customer locations and a plurality of communication sites associated with the service operator (e.g., serving wire centers, central office sites, etc.). In particular, the customer creates a private communication network by identifying communication needs between each pair of the plurality of customer locations, determining the type (e.g., speed, electrical vs. optical, etc.), number, and configuration of required communication facilities to connect each pair of the plurality of customer locations (via one or more intervening service provider sites) to meet the determined communication needs, and purchasing the required communication facilities from the service provider. The customer must also maintain and periodically re-optimize the private communications network.

Over time, a customer may lease dozens to thousands of communications facilities between dozens to thousands of customer locations and service provider sites. Without careful record keeping, maintenance, and optimization, the private communication network created by the customer may contain stranded or excess capacity, may lack sufficient entrance facilities to accommodate additional communication facilities (e.g., physical space to bring more cable into the site or location), and/or may utilize multiple low speed communication facilities rather than more cost effective higher speed communication facilities.

FIG. 1 illustrates an example circuit based communication system configured to provide an example dedicated transport service for a customer. The example system of FIG. 1 includes a plurality of serving wire centers 105A-C. The example of FIG. 1 illustrates an example private communication network including a plurality of end user sites 110A-D, and a plurality of point of presence (POP) sites 115A-B. The plurality of customer sites 110A-D and 115A-B are connected via a plurality a dedicated transport services (i.e., purchased or leased communication facilities). For example, the site 110B is connected via an access facility 120A to the serving wire center 105B which, in turn, is connected via a communication facility 120B to the serving wire center 105A, which is connected via an access facility 120C to the POP site 115A. Throughout this disclosure the term access facility takes on the conventional meaning. That is, an access facility (e.g., the facilities 120A, 120B and 120C) consists of a continuously connected circuit between two end user sites (e.g., the sites 110A-D and/or 115A-B) available to the customer on a full-time, unshared, basis, which is used for the origination or termination of communication services.

In the illustrated example of FIG. 1, demarcation points 130A-F delineate borders between end user sites (e.g., the sites 110A-D and/or 115A-B) and the communications network (e.g., comprised for example of sites 105A-C, facilities 120A-C and 125A-C) operated by the service provider. Demarcation points may be active or passive, for example, wiring closets, digital loop carrier equipment, etc. In the case of an electronic or active demarcation point, the transmission speeds and protocols in use on each side of the demarcation point may be different. For example, a demarcation point may support an OC-48 circuit on the service provider's side and DS1 or DS3 circuits on the customer's side. By convention, each access facility has a demarcation point. However, throughout this disclosure the singular term demarcation point is used for demarcation points co-located at a single customer site.

The plurality of serving wire centers 105A-C may be connected with additional communication facilities (e.g., facilities 125A-C). The additional facilities 125A-C may be used to transport other communication services provided directed by the service provider (e.g., plain old telephone service (POTS), etc.). It will be readily apparent to persons of ordinary skill in the art that a communication facility purchased by the customer (e.g., the facility 120B) may be aggregated together with (e.g., transported within a portion of the bandwidth of) one of the additional communication facilities (e.g., the facility 125A). However, from the perspective of the customer and the service provider, the purchased communication facilities are virtual circuits that are carried parallel to the additional facilities (e.g., the facilities 125A-C). That is, the service provider can not use any of the bandwidth associated with a facility purchased by the customer (e.g., facility 120B) to transport the other communications services provided directly by the service provider. Also, the customer can not use available bandwidth from one of the additional communication facilities (e.g., the facilities 125A-C) as part of their private communication network.

### BRIEF DESCRIPTION OF THE DRAWINGS

FIG. 1 is a schematic illustration of a known circuit based communication system.

FIG. 2 is a schematic illustration of an example circuit based communication system capable of providing integrated bandwidth dedicated transport communication services.

FIGS. 3A and 3B illustrate an example network optimization performed to convert from an example dedicated transport service to an example integrated bandwidth dedicated transport service.

### DETAILED DESCRIPTION

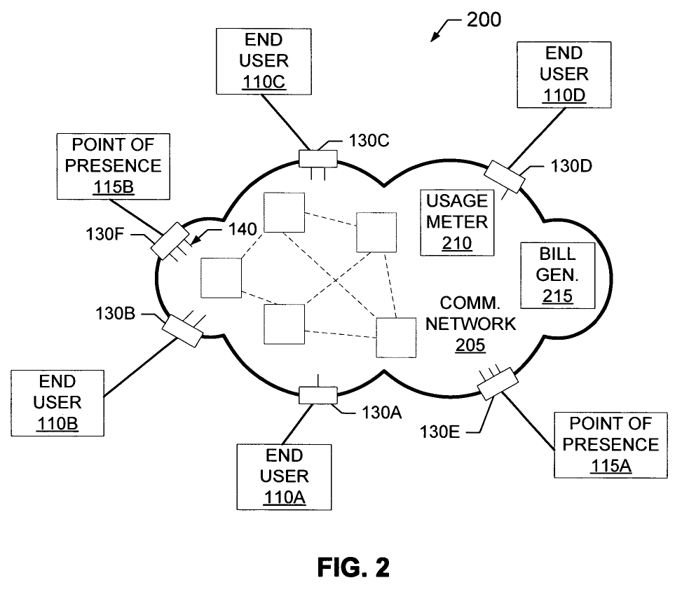

FIG. 2 illustrates an example communication system 200 constructed in accordance with the teachings of the invention that provides integrated bandwidth dedicated transport services. In the example of FIG. 2, the plurality of communication sites associated with the service operator (e.g., serving wire centers, central office sites, etc.) are viewed collectively, from the perspective of the customer, as an aggregate circuit based communications network 205 (depicted as the “cloud” 205 in FIG. 2).

In the illustrated example of FIG. 2, each of a plurality of customer sites (e.g., end user sites 110A-D, POP sites 115A-B, etc.) are connected to the circuit based network 205 at the demarcation points 130A-F. On the service provider's side of a demarcation point existing access facilities may continue being used. For example, beyond the demarcation point 130F, the POP site 115B could continue to communicate with the network 205 via the plurality of access facilities 140. It will be apparent that, for operational efficiencies, a service provider may elect to multiplex and/or de-multiplex access facilities within the network 205. For example, by replacing or upgrading equipment at a demarcation point, by implanting a multiplexer within a serving wire center, etc. Further, a customer may request that one or more access facilities be replaced with a different number and/or type of access facilities. For example, a customer currently utilizing three DS1 access facilities at a demarcation point may elect to convert to a single DS3 access facility to reduce costs associated with access facilities for the customer site or to upgrade the communications capacity of the customer site.

A first characteristic of the example of FIG. 2 is that the network 205 is connected to each customer site (e.g., site 110D) via a demarcation point or access port (e.g., demarcation point 130D or access port 130D). In the illustrated example of FIG. 2, each access port (e.g., access port 130F) has at least one attribute that represents the access speed(s) (e.g., bandwidth, connection speed, etc.) of the plurality of access facilities serving the access port. A second characteristic is that the customer is no longer responsible for determining and specifying transmission paths within the network 205 between customer sites.

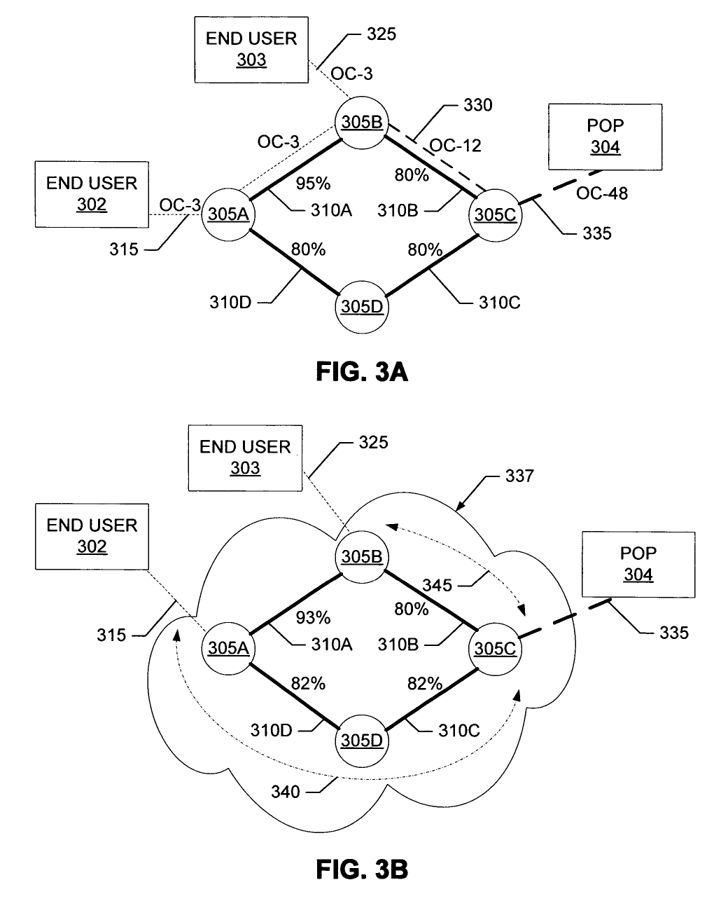

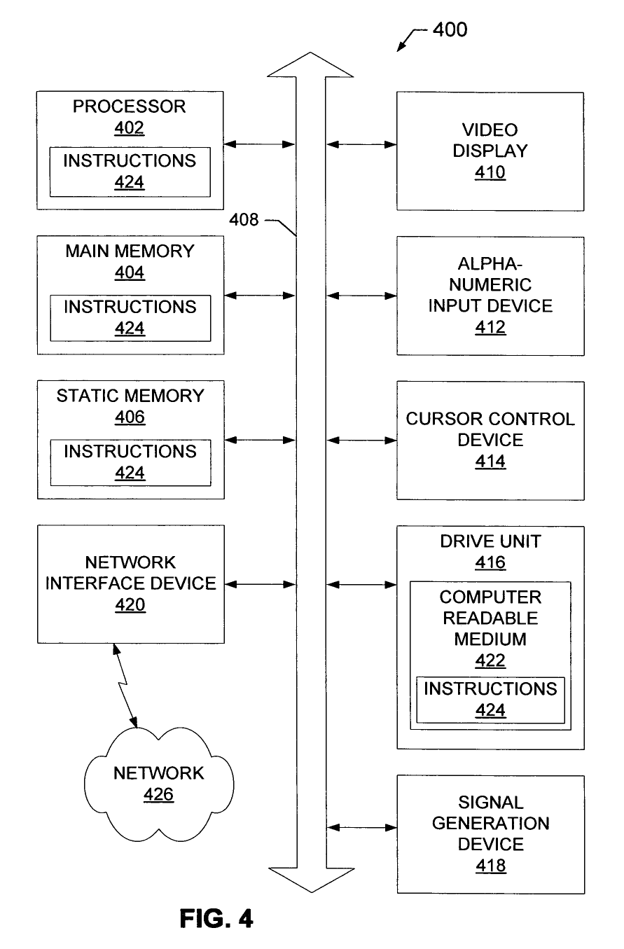

In the example of FIG. 2, the service provider configures the network 205 to transport the customer's communication data between each of the customer's access ports. As is discussed below in connection with FIGS. 3A and 3B, the service provider chooses a path for the customer's data by using one or more of a variety of network engineering tools and techniques suitable for configuring the service provider's network 205. For instance, each service provider's network 205 typically consists of different types of sites and communication facilities, a different number of sites and communication facilities, a different configuration of sites and facilities (i.e., how the sites are connected with which facilities), and multiple customers. Thus, the service provider chooses appropriate paths for each of its customer's data based on predetermined bandwidth requirements for each individual customer site (i.e., the access speed of access port associated with the customer site), the relative locations of customer sites (i.e., which service provider site is connected to which customer site(s)), the current facility usage, facility availability, bandwidth availability on facilities, network traffic engineering rules, network load balancing, etc.

As discussed above, in the example system 200 of FIG. 2 the customer is not responsible for selecting specific communication facilities and/or communication facility configuration(s) within the network 205 to create the customer's private network(s). Instead, the customer is only concerned with determining the plurality access facilities (e.g., speed, electrical vs. optical, etc.) associated with the access port for each customer site. This eliminates the need for the customer to design, maintain, and optimize their private network(s) as is the case with some known systems. Further, the illustrated example substantially eliminates the possibility of stranded, excess, or under-utilized communication bandwidth or facilities. Thus, the customer's costs and management overhead associated with the customer's private network may be significantly reduced.

While, in the example of FIG. 2, the service provider assumes responsibility for managing the transport of the customer's data, the service provider obtains additional operational efficiencies and cost savings by managing the bandwidth associated with the customer's data together with the bandwidth associated with all other communication services provided by the service provider. For instance, a service provider is free to choose a route (i.e., path through the network 205) for the customer's data to use a more direct route, or to take advantage of existing under-utilized facilities rather than either having to construct new facilities or having to transport them along previously predetermined routes selected and specified by the customer.

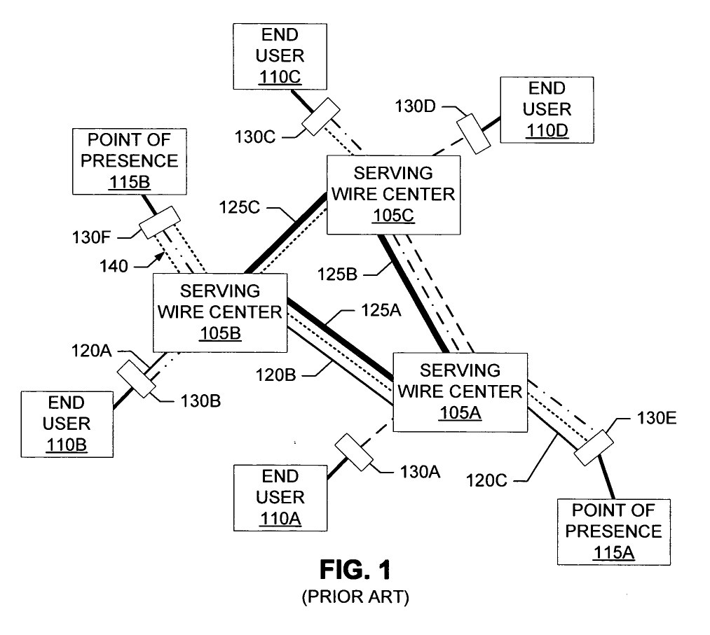

FIGS. 3A and 3B illustrate an example network optimization performed to convert an example customer designed and managed dedicated transport service to an example integrated bandwidth dedicated transport service. For clarity, demarcation points are not shown in either FIG. 3A or 3B. It will be understood that demarcation points are present in the illustrated examples of FIGS. 3A and 3B in the same fashion illustrated in FIGS. 1 and 2. FIG. 3A illustrates a portion of an example private communications network consisting of two end user sites 302 and 303 and one POP site 304. Also illustrated in FIG. 3A are a plurality of service provider sites 305A-D connected in a ring topology with a plurality of communication facilities 310A-D having facility loads (i.e., utilizations, bandwidth usages) illustrated as percentages in FIG. 3A (e.g., the facility 310A is operating at 95% of capacity). The customer's private network consists of a demarcation point associated with the customer site 302 connected to a first OC-3 facility 315 transported thru the service provider site 305A to the service provider site 305B. A second OC-3 facility 325 is connected between a demarcation point associated with the customer site 303 and the service provider site 305B. A multiplexer at the service provider site 305B combines the OC-3 circuits 315 and 325 with other circuits associated with the customer to form an OC-12 circuit 330 transported to the service provider site 305C. Finally, a multiplexer at the service provider site 305C combines the OC-12 circuit 330 with other circuits associated with the POP 304 onto an OC-48 facility 335 located between the service provider site 305C and a demarcation point associated with the customer site 304.

FIG. 3B illustrates an example conversion of the example customer designed, configured, specified, and private communication network of FIG. 3A into an example integrated bandwidth dedicated transport service. In the example of FIG. 3B, the customer's private network(s) consists of the plurality of customer sites 302, 303 and 304, each of which is connected to an aggregate circuit based network 337 via a plurality of access points (i.e., demarcation points). However, in contrast to the example of FIG. 3A, with the example of FIG. 3B the customer no longer designs, configures, specifies, or manages the communication facilities utilized within the network 337.

As discussed above, the service provider selects routes through the network 337 for the customer's data using one or more of a variety of network engineering tools and techniques suitable for configuring the service provider's network. FIG. 3B illustrates example routes 340 (for traffic between sites 302 and 304) and 345 (for traffic between sites 303 and 304) selected based upon a criterion of facility utilization. As illustrated in FIG. 3A, prior to converting the customer's private network to an integrated bandwidth service, the facility 310A had a bandwidth utilization of 95% (including the customer's OC-3 circuit bandwidth). Thus, in the example of FIG. 3B the route chosen from the customer site 302 (i.e., the demarcation point associated with the customer site 302) to the customer site 304 uses the less utilized facility 310D from the service provider site 305A (the site to which the customer site 302 is attached) to the service provider site 305D, and the less utilized facility 310C from the service provider site 305D to the service provider site 305C (the site to which the customer site 304 is attached). By selecting this route, the service provider reduces the loading on the facility 310A and establishes a more balanced network loading (i.e., bandwidth utilization).

Returning to FIG. 2, it should be recognized that other network engineering tools and techniques could be utilized. For example, the routes chosen between customer sites could be chosen based on mileage, facility reliability, a desire for facility redundancy, etc. As the equipment, configuration and facility utilization comprising each service provider's network 205 are typically unique; the selection of routes to connect the various example customer sites 110A-D and 115A-B is highly individualized to each service provider.

While the methods, services, and communication networks were described above in reference to specific examples providing integrated bandwidth dedicated transport services, it should be noted that it is understood that the teachings of the invention are not limited to such examples. For example, the network 205 could be constructed in a mesh, star, optical ring, or any other configuration. Further, the service provider is not limited to any particular method, tool, or technique for determining, selecting, configuring, providing, maintaining, and/or optimizing transport paths for the customer's data through the network 205. It is understood that the service provider uses a method, tool, or technique suitable for their particular network 205 and based upon its specific business objectives and network engineering constraints.

It will be understood that the network 205 could be connected to a non-circuit based network (e.g., an asynchronous transfer mode (ATM) network, an Internet Protocol (IP) network, a frame relay network, etc.). For instance, the network 205 may provide additional transport paths for the customer's data through the network 205 to and from the non-circuit based network and the customer sites 110A-D and 115A-B. Further, one or more of the customer sites 110A-D and 115A-B may be connected to the network 205 via the non-circuit based network.

In the example of FIG. 2, the service provider charges the customer for the integrated bandwidth dedicated transport service based upon the composition of access facilities associated with each of the customer's access port (i.e., each demarcation point 130A-F) to the network 205 (i.e., an actual access bandwidth) independent of the underlying transport services being carried. To determine actual access bandwidths, the network 205 includes at least one bandwidth usage meter 210. In the example of FIG. 2, actual access bandwidth is recorded in pro-rated units of bandwidth, where a unit of bandwidth attributable to an access facility depends upon the access speed and type of the access facility. For example, a Digital Service Level 0 (DS0) circuit accrues access bandwidth in increments of 0.01 units of bandwidth per month, a DS1 circuit accrues bandwidth in increments of 0.15 units of bandwidth per month, and a DS3 circuit accrues bandwidth in increments of 1 unit of bandwidth per month, etc. In particular, to determine access bandwidth for an access port, the usage meter 210 adds up accrued access bandwidth for all access facilities associated with the access port. The accrued access bandwidth for an access facility is the units of bandwidth per month based upon the access facility speed and type pro-rated by the percentage of days in a month the access facility was active.

To bill the customer for actual access bandwidth, the example network 205 includes a bill generator 215. The bill generator 215 determines the charge to the customer for the provided integrated bandwidth dedicated transport service. In the example of FIG. 2, the bill generator 215 bills the customer based on the total accrued access bandwidth for all of the customer's sites (i.e., access ports). The bill generator 215 may also bill the customer for additional charges associated with access facilities, for example, mileage between a demarcation point and a serving wire center, etc. In the illustrated example, the bill generator 215 also tracks total access bandwidth versus a contractual commitment agreed to by the customer and the service provider. For example, if total actual access bandwidth for a month falls below a minimum amount, the customer is billed a pre-determined minimum amount.

The example bill generator 215 also compares total yearly charges billed to the customer to a contractual minimum. For example, the customer may be provided with wholesale rates and, in return, agree to a minimum amount of yearly revenue (from the service provider's perspective). In particular, the bill generator 215 totals all charges billed to the customer over the twelve months preceding the anniversary date for the customer's service. If the total of the charges falls below a percentage of a pre-agreed minimum (e.g., 95%), the bill generator 215 notifies the customer of the deficiency. The customer has the option to increase utilization to meet or exceed the pre-agreed minimum, or the contract may be terminated by the service provider and termination liability charges billed to the customer.

The usage meter 210 and the bill generator 215 can be implemented using any one of a variety of well known computing devices or platforms. For example, a Personal Computer (PC) or computing device capable to determine, track and record active access facilities may be used to implement the usage meter 210. An example PC can implement the bill generator 215 by collecting from one or more usage meters actual access bandwidth data and generating customer bills (e.g., paper bills, electronic bills, electronic debits, etc.) from the access bandwidth data. It should be apparent that the usage meter 210 and the bill generator 215 could be implemented by a single device or computing platform.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. Moreover, the computer system 400 can include a main memory 404 and a static memory 406 that can communicate with each other via a bus 408. As shown, the computer system 400 may further include a video display unit 410, such as a liquid crystal display (LCD), an organic light emitting diode (OLED), a flat panel display, a solid state display, or a cathode ray tube (CRT). Additionally, the computer system 400 may include an input device 412, such as a keyboard, and a cursor control device 414, such as a mouse. The computer system 400 can also include a disk drive unit 416, a signal generation device 418, such as a speaker or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 424 or receives and executes instructions 424 responsive to a propagated signal, so that a device connected to a network 426 can communicate voice, video or data over the network 426. Further, the instructions 424 may be transmitted or received over the network 426 via the network interface device 420.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of delivering a communication service comprising:
providing a customer with first and second access ports to a circuit based communications network, wherein each access port has at least one associated bandwidth attribute; and
configuring the communications network to route traffic between the first and second access ports in response to an operator of the communications network.

2. A method as defined in claim 1, wherein the first and second access ports are located within a single or different local access transport areas.

3. A method as defined in claim 1, wherein the circuit based communications network is communicatively coupled to a non-circuit based communications network.

4. A method as defined in claim 3, wherein the second access port to the circuit based communications network is via the non-circuit based communications network.

5. A method as defined in claim 1, further comprising charging the customer based on actual access bandwidths for the first and second access ports.

6. A method as defined in claim 5, wherein the actual access bandwidths are accrued in units of bandwidth.

7. A method as defined in claim 6, wherein an accrual rate for the units of bandwidth depends upon the at least one bandwidth attribute associated with at least one of the first or second access ports.

8. A method as defined in claim 1, wherein configuring the communications network to route traffic between the first and second access ports comprises choosing a path through the communications network based on at least one of facility usage, facility availability, bandwidth availability, network traffic engineering rules, or network load balancing.

9. A communication system capable of delivering a communication service comprising:
a circuit based communications network; and
first and second access ports to provide access to the communication network by a customer, wherein each access port has at least one associated access speed, and wherein the communications network is configured to transport data between the first and second access ports along a path not selected or controllable by the customer.

10. A system as defined in claim 9, wherein the first and second access ports are located within a single or different local access transport areas.

11. A system as defined in claim 9, wherein the circuit based communications network is communicatively coupled to a non-circuit based communications network.

12. A system as defined in claim 1 1, wherein the second access port has access to the circuit based communications network via the non-circuit based communications network.

13. A system as defined in claim 9, further comprising a bandwidth usage meter to track actual access bandwidths for the first and second access ports.

14. A system as defined in claim 13, further comprising a bill generator to bill the customer for the dedicated transport service based upon the actual access bandwidths.

15. A system as defined in claim 13, wherein actual access bandwidths are tracked in units of bandwidth.

16. A system as defined in claim 15, wherein the units of bandwidth is based on the at least one access speed associated with at least one of the first and second access ports.

17. A system as defined in claim 9, wherein the communications network is configured to transport data between the first and second access ports by choosing a path through the communications network based on at least one of facility usage, facility availability, bandwidth availability, network traffic engineering rules, or network load balancing.

18. In a communication system configured to provide a communication service, a method comprising:
configuring at least one access facility for each of a first and second access port;
configuring a circuit based communications network to transport communications data between the first and second access ports;
recording access bandwidths for each of the first and second access ports; and
charging a customer for the dedicated transport communication service based upon the recorded access bandwidths.

19. A method as defined in claim 18, wherein the first and second access ports are located within a single or different local access transport areas.

20. A method as defined in claim 18, wherein the circuit based communications network is communicatively coupled to a non-circuit based communications network.

21. A method as defined in claim 20, wherein the at least one access facility for the second access port is connected to the non-circuit based communications network.

22. A method as defined in claim 18, wherein access bandwidths are recorded in units of bandwidth.

23. A method as defined in claim 22, wherein the units of bandwidth is based on the at least one access facility associated with one of the first and second access ports.

24. A method as defined in claim 18, wherein configuring the circuit based communications network is performed in response to an operator of the communications network.

25. A method as defined in claim 18, wherein configuring the circuit based communications network to transport communications data between the first and second access ports comprises choosing a path through the communications network based on at least one of facility usage, facility availability, bandwidth availability, network traffic engineering rules, or network load balancing.

26. A transport service comprising:
first and second access ports for a circuit based communications network; and
a communication path through the communications network to transport communications data between the first and second access ports, wherein the communication path is not determined by a customer associated with either of the first or the second access ports and wherein charges for the transport service are determined from actual access bandwidths for the first and second access ports.

27. A service as defined in claim 26, wherein the first and second access ports are located within a single or different local access transport areas.

28. A service as defined in claim 26, wherein the circuit based communications network is communicatively coupled to a non-circuit based communications network.

29. A service as defined in claim 28, wherein the second access port to the circuit based communications network is via the non-circuit based communications network.

30. A service as defined in claim 26, wherein the actual access bandwidths for the first and second access ports are recorded in units of bandwidth.

31. A service as defined in claim 30, wherein the units of bandwidth are based on at least one bandwidth attribute associated with at least one of the first and second access ports.

32. A service as defined in claim 26, wherein the path is chosen by an operator of the communications network based on at least one of facility usage, facility availability, bandwidth availability, network traffic engineering rules, or network load balancing.
